(19) United States
(12) Patent Application Publication
(10) Pub. No.: US 2019/0375397 A1
(43) Pub. Date: Dec. 12, 2019

(54) VEHICLE CONTROL DEVICE INCLUDED IN VEHICLE AND CONTROL METHOD FOR VEHICLE

(71) Applicant: LG Electronics Inc., Seoul (KR)

(72) Inventors: Hyeonju BAE, Seoul (KR); Jonghwa YOON, Seoul (KR)

(21) Appl. No.: 16/469,386

(22) PCT Filed: Jan. 2, 2017
(86) PCT No.: PCT/KR2017/000017

§ 371 Date: Jun. 13, 2019

(30) Foreign Application Priority Data
Dec. 13, 2016 (KR) 10-2016-0169764

(51) Int. Cl. B60W 30/06; B60W 40/06; B60W 50/14; G08G 1/16

(52) U.S. Cl. CPC B60W 30/06; B60W 40/06; B60W 50/14; B60Y 2400/92; B60W 2050/146; B60Y 2300/06; G08G 1/168

(57) ABSTRACT

The present invention relates to a vehicle control device included in a vehicle and a control method for the vehicle. According to one embodiment of the present invention, the vehicle control device, comprises: a sensing unit for sensing peripheral information of the vehicle; a display unit; and a processor for determining a parking space in which the vehicle can be parked on the basis of the sensed peripheral information, and outputting information related to the determined parking space on the display unit, wherein the processor outputs the information related to the parking space on the display unit in different methods on the basis of the type of road on which the vehicle is located.

### TECHNICAL FIELD

The present invention relates to a vehicle control device provided in a vehicle and a control method of the vehicle.

### BACKGROUND ART

A vehicle is an apparatus capable of moving a user in the user-desired direction. A representative example of a vehicle may be an automobile.

Meanwhile, for convenience of a user using a vehicle, various types of sensors and electronic devices are provided in the vehicle. Specifically, a study on an Advanced Driver Assistance System (ADAS) is actively undergoing. In addition, an autonomous vehicle is actively under development.

A vehicle may be provided with various types of lamps. In general, the vehicle includes various vehicle lamps having a lighting function of facilitating articles or objects near the vehicle to be recognized during driving at night, and a signaling function of notifying a driving state of the vehicle to other vehicles or pedestrians.

For example, the vehicle may include devices operating in a manner of directly emitting light using lamps, such as a head lamp emitting light to a front side to ensure a driver's view, a brake lamp turned on when slamming the brake on, turn indicator lamps used upon a left turn or a right turn.

As another example, reflectors for reflecting light to facilitate the vehicle to be recognized from outside are mounted on front and rear sides of the vehicle.

Installation criteria and standards of the lamps for the vehicle are regulated as rules to fully exhibit each function.

Meanwhile, as the development of the advanced driving assist system (ADAS) is actively undergoing in recent time, development of a technology for optimizing user's convenience and safety while driving a vehicle is required.

As a part of this, in order to park a vehicle, there is a need to develop a UI/UX capable of more effectively inform a driver of a space available for parking.

### DISCLOSURE

### Technical Problem

Therefore, an object of the present invention is to provide a vehicle control device and a control method of a vehicle capable of providing information related to parking in an optimized manner when a vehicle is parked.

Another object of the present invention is to provide a vehicle control device and a vehicle control method capable of providing a user interface related to parking in a manner optimized according to the surrounding environment when a vehicle is parked.

It is still another object of the present invention to provide a vehicle control device and a vehicle control method capable of providing an optimized method of searching for a space available for parking according to the surrounding environment when a vehicle is parked.

The problems of the present invention are not limited to the above-mentioned problems, and other problems not mentioned may be clearly understood by those skilled in the art from the following description.

### Technical Solution

According to an aspect of the present invention, there is provided a vehicle control device provided in a vehicle, including: a sensing unit for sensing peripheral information of the vehicle; a display unit; and a processor for determining a parking space in which the vehicle can be parked on the basis of the sensed peripheral information, and outputting information related to the determined parking space on the display unit, wherein the processor outputs the information related to the parking space on the display unit in different methods on the basis of the type of road on which the vehicle is located.

In an embodiment, if the type of the road on which the vehicle is located is a first type, the processor may output information related to the parking space detected on the left and right sides of the vehicle on the display unit, and if the type of the road on which the vehicle is located is a second type different from the first type, the processor may output information related to the parking space detected from any one of the left and right sides of the vehicle on the display unit.

In an embodiment, the processor may output, on the display unit, information related to a parking space existing in a direction opposite to a direction in which a center line of the left and right sides of the vehicle is detected in the second type road.

In an embodiment, when preset information is sensed in the parking space the processor may determine that the corresponding parking space is a space in which parking is prohibited.

In an embodiment, the processor may output the parking space in which the vehicle can be parked and the space in which parking is inhibited, so as to be visually distinguished from each other.

In an embodiment, when a lane in which the vehicle is running is a preset lane, the processor may output information related to the parking space on the display unit, and when the lane in which the vehicle is running is not the preset lane, the processor may output information indicating that parking is impossible in the lane on the display unit.

In an embodiment, the processor may control the sensing unit to sense to sense peripheral information required for determining the parking space in which the vehicle can be parked in different areas based on the type of the road on which the vehicle is located.

In an embodiment, if the road on which the vehicle is located is a first type road, the processor may sense the peripheral information in a left area and a right area of the vehicle, and if the road on which the vehicle is located is a second type road different from the first type road, the processor may sense the peripheral information only in any one of the left area and the right area.

In an embodiment, if the road on which the vehicle is located is the second type road, the processor may control the sensing unit to sense the peripheral information in an area in which the center line is not included, among the left area and the right area.

In an embodiment, when the vehicle is located in a parking lot, the processor may output information related to the parking space in which the vehicle can be parked on the display unit in different manners according to whether a corresponding parking passage is a one-way road or a two-way road.

In an embodiment, when the vehicle passes by a specific point based on the parking space in which the vehicle can be parked, the processor may change the information related to the parking space output on the display unit from the parking available space to a parking unavailable space.

In an embodiment, the specific point may be varied depending on the type of road on which the vehicle is located.

In an embodiment, when a touch is applied to the information related to the parking space output on the display unit, the processor may automatically park the vehicle.

A vehicle according to an embodiment of the present invention includes the vehicle control device described in this specification.

According to another aspect of the present invention, there is provided a method of controlling a vehicle including a vehicle control device, including sensing peripheral information of a vehicle; determining a parking space in which the vehicle can be parked based on the sensed peripheral information; and outputting information related to the determined parking space on the display unit, wherein, in the outputting, the information related to the parking space is output on the display unit in different manners based on the type of a road on which the vehicle is located.

The details of other embodiments are included in the detailed description and drawings.

### Advantageous Effects

According to an embodiment of the present invention, one or more of the following advantages are obtained.

First, according to the present invention, information related to a parking space is output on the display unit in a different manner based on a type of a road on which a vehicle is located when the vehicle is parked, thereby providing a new user interface for informing a user about a parking space according to situations in an optimized manner.

Secondly, in the present invention, when a vehicle is to be parked, a space available for parking and a space unavailable for parking are displayed to be visually differentiated from each other, thereby effectively informing a user about whether a corresponding parking space is available for parking.

Thirdly, according to the present invention, peripheral information necessary for determining a parking space is sensed from different areas based on a type of a road on which a vehicle is located when the vehicle is parked, thereby effectively controlling a sensor, a parking space is searched based on a large area as a target according to situations, or a parking space is precisely searched in a partial region.

The effects of the present invention are not limited to the effects mentioned above, and other effects not mentioned may be clearly understood by those skilled in the art from the description of the claims.

### DESCRIPTION OF DRAWINGS

FIG. 1 is a view showing an appearance of a vehicle according to an embodiment of the present invention.

FIG. 2 is a view of a vehicle according to an embodiment of the present invention viewed from various angles.

FIGS. 3 and 4 are views showing an interior of a vehicle according to an embodiment of the present invention.

FIGS. 5 to 6 are views referred to explain an object according to an embodiment of the present invention.

FIG. 7 is a block diagram for explaining a vehicle according to an embodiment of the present invention.

FIG. 8 is a conceptual diagram for explaining a vehicle control device according to an embodiment of the present invention.

FIG. 9 is a flowchart for explaining a typical control method of the present invention.

FIGS. 10A, 10B, 11A, 11B, 11C, and 12 are conceptual diagrams for explaining the control method shown in FIG. 9.

FIGS. 13, 14A, 14B, 15A, 15B, 15C and 15D are conceptual diagrams for explaining various embodiments of the present invention.

### MODE FOR INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In describing the present disclosure, if a detailed explanation for a related known function or construction is considered to unnecessarily divert the gist of the present disclosure, such explanation has been omitted but would be understood by those skilled in the art. The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the another element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle according to an embodiment of the present invention may be understood as a conception including cars, motorcycles and the like. Hereinafter, the vehicle will be described based on a car.

The vehicle according to the embodiment of the present invention may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

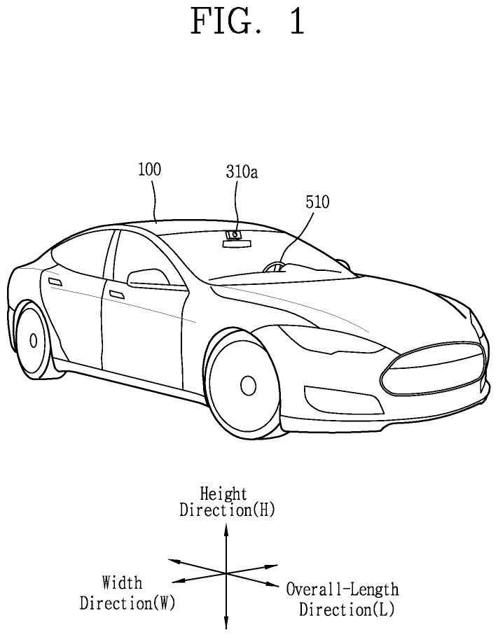

FIG. 1 is a view illustrating appearance of a vehicle in accordance with an embodiment of the present invention.

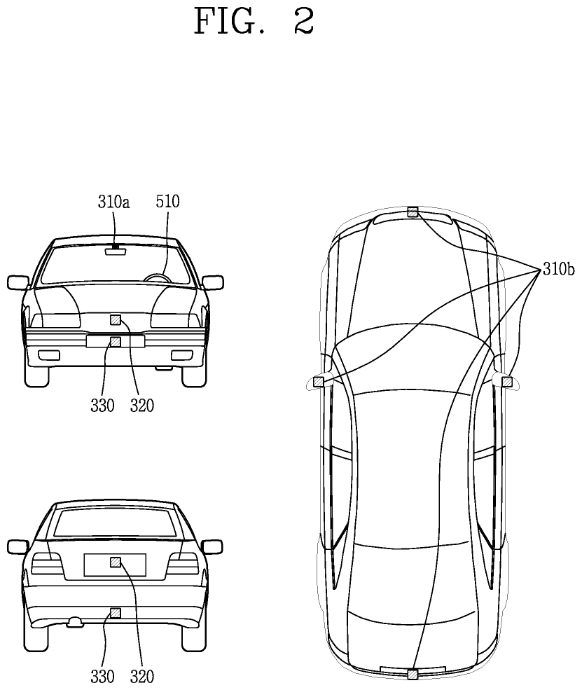

FIG. 2 is a view illustrating appearance of a vehicle at various angles in accordance with an embodiment of the present invention.

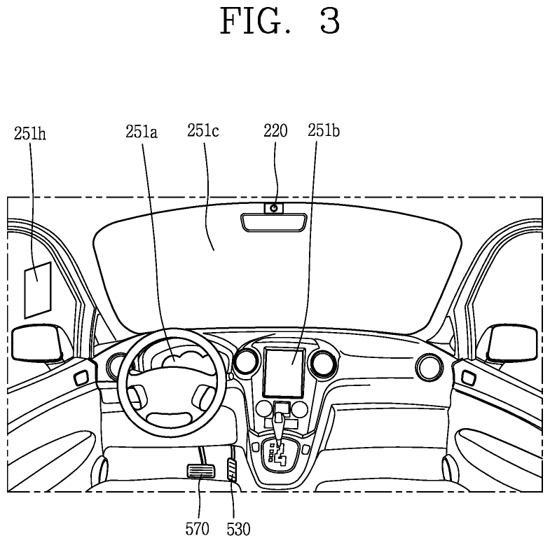

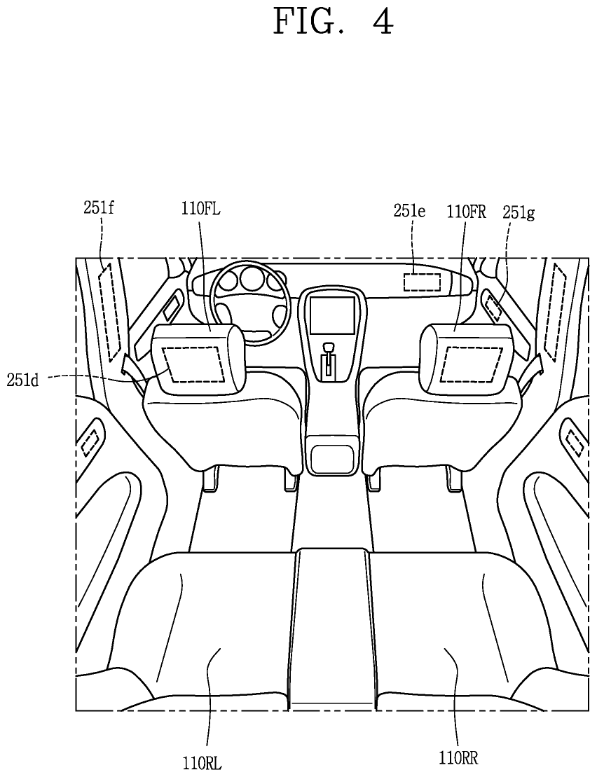

FIGS. 3 and 4 are views illustrating an inside of a vehicle in accordance with an embodiment of the present invention.

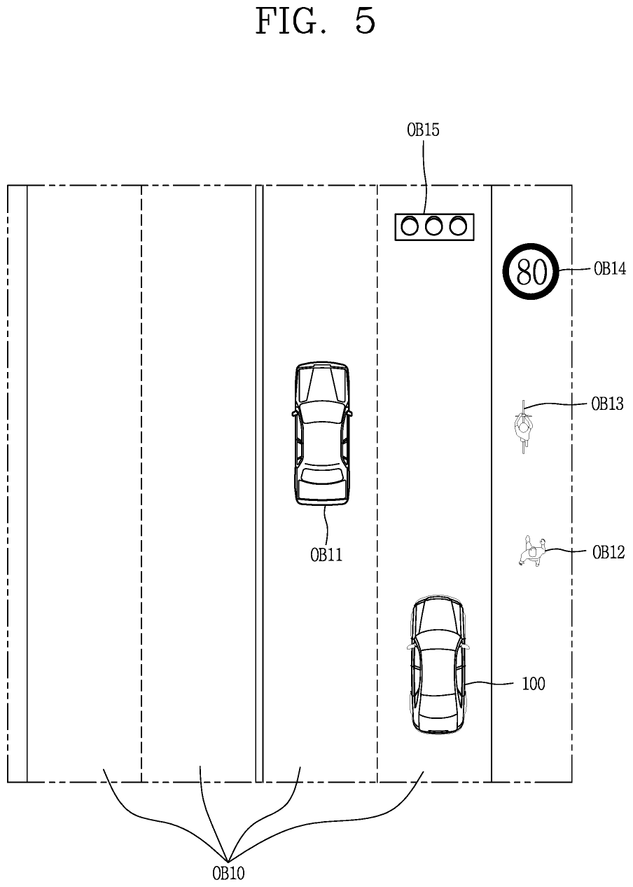

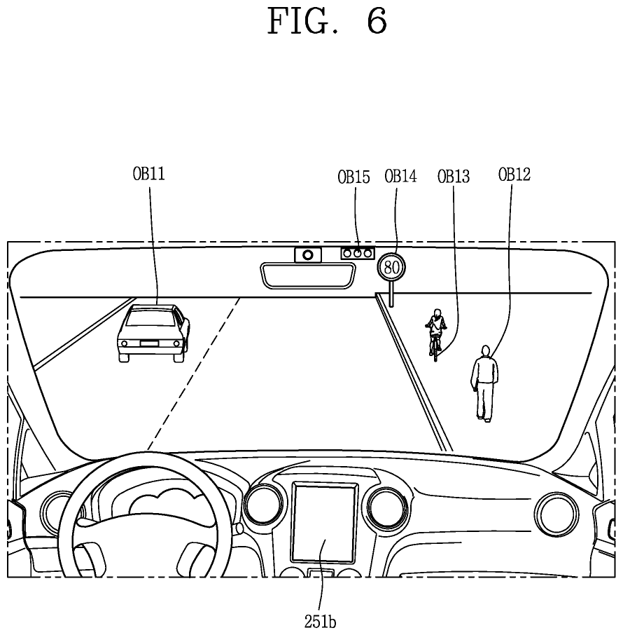

FIGS. 5 and 6 are reference views illustrating objects in accordance with an embodiment of the present invention.

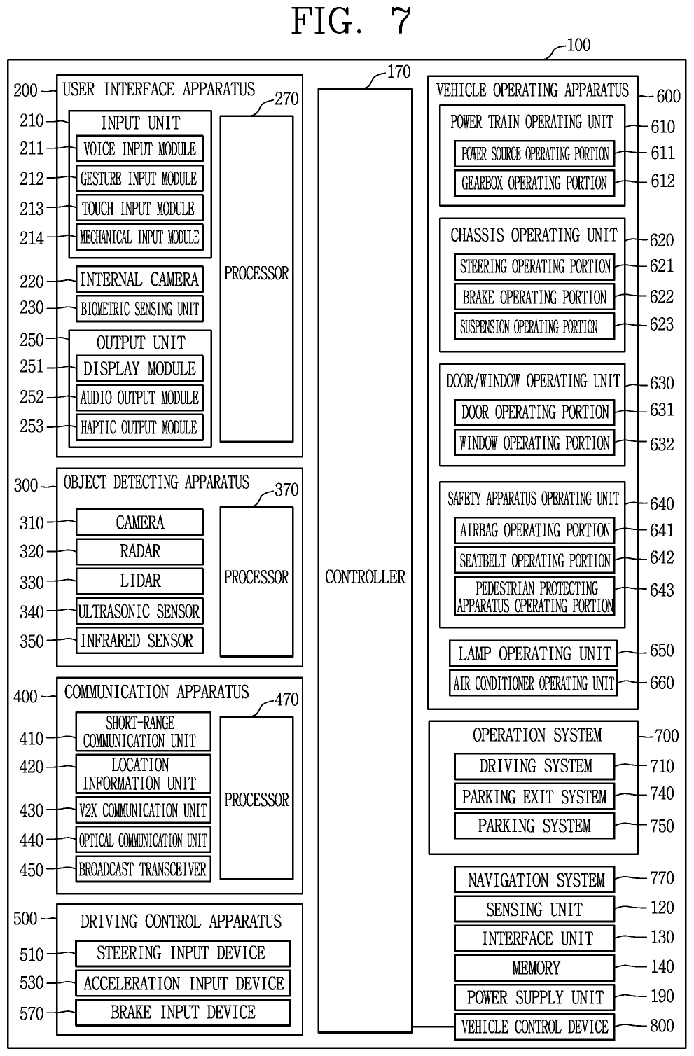

FIG. 7 is a block diagram illustrating a vehicle in accordance with an embodiment of the present invention.

As illustrated in FIGS. 1 to 7, a vehicle 100 may include wheels turning by a driving force, and a steering apparatus 510 for adjusting a driving (ongoing, moving) direction of the vehicle 100.

The vehicle 100 may be an autonomous vehicle.

The vehicle 100 may be switched into an autonomous mode or a manual mode based on a user input.

For example, the vehicle may be converted from the manual mode into the autonomous mode or from the autonomous mode into the manual mode based on a user input received through a user interface apparatus 200.

The vehicle 100 may be switched into the autonomous mode or the manual mode based on driving environment information. The driving environment information may be generated based on object information provided from an object detecting apparatus 300.

For example, the vehicle 100 may be switched from the manual mode into the autonomous mode or from the autonomous module into the manual mode based on driving environment information generated in the object detecting apparatus 300.

In an example, the vehicle 100 may be switched from the manual mode into the autonomous mode or from the autonomous module into the manual mode based on driving environment information received through a communication apparatus 400.

The vehicle 100 may be switched from the manual mode into the autonomous mode or from the autonomous module into the manual mode based on information, data or signal provided from an external device.

When the vehicle 100 is driven in the autonomous mode, the autonomous vehicle 100 may be driven based on an operation system 700.

For example, the autonomous vehicle 100 may be driven based on information, data or signal generated in a driving system 710, a parking exit system 740 and a parking system 750.

When the vehicle 100 is driven in the manual mode, the autonomous vehicle 100 may receive a user input for driving through a driving control apparatus 500. The vehicle 100 may be driven based on the user input received through the driving control apparatus 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which is a criterion for measuring the overall length of the vehicle 100, a width direction W may refer to a direction that is a criterion for measuring a width of the vehicle 100, and a height direction H may refer to a direction that is a criterion for measuring a height of the vehicle 100.

As illustrated in FIG. 7, the vehicle 100 may include a user interface apparatus 200, an object detecting apparatus 300, a communication apparatus 400, a driving control apparatus 500, a vehicle operating apparatus 600, an operation system 700, a navigation system 770, a sensing unit 120, an interface unit 130, a memory 140, a controller 170 and a power supply unit 190.

According to embodiments, the vehicle 100 may include more components in addition to components to be explained in this specification or may not include some of those components to be explained in this specification.

The user interface apparatus 200 is an apparatus for communication between the vehicle 100 and a user. The user interface apparatus 200 may receive a user input and provide information generated in the vehicle 100 to the user. The vehicle 200 may implement user interfaces (UIs) or user experiences (UXs) through the user interface apparatus 200.

The user interface apparatus 200 may include an input unit 210, an internal camera 220, a biometric sensing unit 230, an output unit 250 and a processor 270.

According to embodiments, the user interface apparatus 200 may include more components in addition to components to be explained in this specification or may not include some of those components to be explained in this specification.

The input unit 200 may allow the user to input information. Data collected in the input unit 120 may be analyzed by the processor 270 and processed as a user's control command.

The input unit 200 may be disposed inside the vehicle. For example, the input unit 200 may be disposed on one area of a steering wheel, one area of an instrument panel, one area of a seat, one area of each pillar, one area of a door, one area of a center console, one area of a headlining, one area of a sun visor, one area of a wind shield, one area of a window or the like.

The input unit 200 may include a voice input module 211, a gesture input module 212, a touch input module 213, and a mechanical input module 214.

The audio input module 211 may convert a user's voice input into an electric signal. The converted electric signal may be provided to the processor 270 or the controller 170.

The voice input module 211 may include at least one microphone.

The gesture input module 212 may convert a user's gesture input into an electric signal. The converted electric signal may be provided to the processor 270 or the controller 170.

The gesture input module 212 may include at least one of an infrared sensor and an image sensor for detecting the user's gesture input.

According to embodiments, the gesture input module 212 may detect a user's three-dimensional (3D) gesture input. To this end, the gesture input module 212 may include a light emitting diode outputting a plurality of infrared rays or a plurality of image sensors.

The gesture input module 212 may detect the user's 3D gesture input by a time of flight (TOF) method, a structured light method or a disparity method.

The touch input module 213 may convert the user's touch input into an electric signal. The converted electric signal may be provided to the processor 270 or the controller 170.

The touch input module 213 may include a touch sensor for detecting the user's touch input.

According to an embodiment, the touch input module 213 may be integrated with the display module 251 so as to implement a touch screen. The touch screen may provide an input interface and an output interface between the vehicle 100 and the user.

The mechanical input module 214 may include at least one of a button, a dome switch, a jog wheel and a jog switch. An electric signal generated by the mechanical input module 214 may be provided to the processor 270 or the controller 170.

The mechanical input module 214 may be arranged on a steering wheel, a center fascia, a center console, a cockpit module, a door and the like.

The internal camera 220 may acquire an internal image of the vehicle. The processor 270 may detect a user's state based on the internal image of the vehicle. The processor 270 may acquire information related to the user's gaze from the internal image of the vehicle. The processor 270 may detect a user gesture from the internal image of the vehicle.

The biometric sensing unit 230 may acquire the user's biometric information. The biometric sensing module 230 may include a sensor for detecting the user's biometric information and acquire fingerprint information and heart rate information regarding the user using the sensor. The biometric information may be used for user authentication.

The output unit 250 may generate an output related to a visual, audible or tactile signal.

The output unit 250 may include at least one of a display module 251, an audio output module 252 and a haptic output module 253.

The display module 251 may output graphic objects corresponding to various types of information.

The display module 251 may include at least one of a liquid crystal display (LCD), a thin film transistor-LCD (TFT LCD), an organic light-emitting diode (OLED), a flexible display, a three-dimensional (3D) display and an e-ink display.

The display module 251 may be inter-layered or integrated with a touch input module 213 to implement a touch screen.

The display module 251 may be implemented as a head up display (HUD). When the display module 251 is implemented as the HUD, the display module 251 may be provided with a projecting module so as to output information through an image which is projected on a windshield or a window.

The display module 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent OLED, a transparent LCD, a transmissive transparent display and a transparent LED display. The transparent display may have adjustable transparency.

Meanwhile, the user interface apparatus 200 may include a plurality of display modules 251a to 251g.

The display module 251 may be disposed on one area of a steering wheel, one area 521a, 251b, 251e of an instrument panel, one area 251d of a seat, one area 251f of each pillar, one area 251g of a door, one area of a center console, one area of a headlining or one area of a sun visor, or implemented on one area 251c of a windshield or one area 251h of a window.

The audio output module 252 converts an electric signal provided from the processor 270 or the controller 170 into an audio signal for output. To this end, the audio output module 252 may include at least one speaker.

The haptic output module 253 generates a tactile output. For example, the haptic output module 253 may vibrate the steering wheel, a safety belt, a seat 110FL, 110FR, 110RL, 110RR such that the user can recognize such output.

The processor 270 may control an overall operation of each unit of the user interface apparatus 200.

According to an embodiment, the user interface apparatus 200 may include a plurality of processors 270 or may not include any processor 270.

When the processor 270 is not included in the user interface apparatus 200, the user interface apparatus 200 may operate according to a control of a processor of another apparatus within the vehicle 100 or the controller 170.

Meanwhile, the user interface apparatus 200 may be called as a display apparatus for vehicle.

The user interface apparatus 200 may operate according to the control of the controller 170.

The object detecting apparatus 300 is an apparatus for detecting an object located at outside of the vehicle 100.

The object may be a variety of objects associated with driving (operation) of the vehicle 100.

Referring to FIGS. 5 and 6, an object O may include a traffic lane OB10, another vehicle OB11, a pedestrian OB12, a two-wheeled vehicle OB13, traffic signals OB14 and OB15, light, a road, a structure, a speed hump, a terrain, an animal and the like.

The lane OB01 may be a driving lane, a lane next to the driving lane or a lane on which another vehicle comes in an opposite direction to the vehicle 100. The lanes OB10 may be a concept including left and right lines forming a lane.

The another vehicle OB11 may be a vehicle which is moving around the vehicle 100. The another vehicle OB11 may be a vehicle located within a predetermined distance from the vehicle 100. For example, the another vehicle OB11 may be a vehicle which moves before or after the vehicle 100.

The pedestrian OB12 may be a person located near the vehicle 100. The pedestrian OB12 may be a person located within a predetermined distance from the vehicle 100. For example, the pedestrian OB12 may be a person located on a sidewalk or roadway.

The two-wheeled vehicle OB12 may refer to a vehicle (transportation facility) that is located near the vehicle 100 and moves using two wheels. The two-wheeled vehicle OB12 may be a vehicle that is located within a predetermined distance from the vehicle 100 and has two wheels. For example, the two-wheeled vehicle OB13 may be a motorcycle or a bicycle that is located on a sidewalk or roadway.

The traffic signals may include a traffic light OB15, a traffic sign OB14 and a pattern or text drawn on a road surface.

The light may be light emitted from a lamp provided on another vehicle. The light may be light generated from a streetlamp. The light may be solar light.

The road may include a road surface, a curve, an upward slope, a downward slope and the like.

The structure may be an object that is located near a road and fixed on the ground.

For example, the structure may include a streetlamp, a roadside tree, a building, an electric pole, a traffic light, a bridge and the like.

The terrain may include a mountain, a hill and the like.

Meanwhile, objects may be classified into a moving object and a fixed object. For example, the moving object may be a concept including another vehicle and a pedestrian.

The fixed object may be a concept including a traffic signal, a road and a structure, for example.

The object detecting apparatus 300 may include a camera 310, a radar 320, a LiDAR 330, an ultrasonic sensor 340, an infrared sensor 350 and a processor 370.

According to an embodiment, the object detecting apparatus 300 may further include other components in addition to the components described, or may not include some of the components described.

The camera 310 may be located on an appropriate portion outside the vehicle to acquire an external image of the vehicle. The camera 310 may be a mono camera, a stereo camera 310a, an around view monitoring (AVM) camera 310b or a 360-degree camera.

For example, the camera 310 may be disposed adjacent to a front windshield within the vehicle to acquire a front image of the vehicle. Or, the camera 310 may be disposed adjacent to a front bumper or a radiator grill.

For example, the camera 310 may be disposed adjacent to a rear glass within the vehicle to acquire a rear image of the vehicle. Or, the camera 310 may be disposed adjacent to a rear bumper, a trunk or a tail gate.

For example, the camera 310 may be disposed adjacent to at least one of side windows within the vehicle to acquire a side image of the vehicle. Or, the camera 310 may be disposed adjacent to a side mirror, a fender or a door.

The camera 310 may provide an acquired image to the processor 370.

The radar 320 may include electric wave transmitting and receiving portions. The radar 320 may be implemented as a pulse radar or a continuous wave radar according to a principle of emitting electric waves. The radar 320 may be implemented in a frequency modulated continuous wave (FMCW) manner or a frequency shift Keyong (FSK) manner according to a signal waveform, among the continuous wave radar methods.

The radar 320 may detect an object in a time of flight (TOF) manner or a phase-shift manner through the medium of the electric wave, and detect a position of the detected object, a distance from the detected object and a relative speed with the detected object.

The radar 320 may be disposed on an appropriate position outside the vehicle for detecting an object which is located at a front, rear or side of the vehicle.

The LiDAR 330 may include laser transmitting and receiving portions. The LiDAR 330 may be implemented in a time of flight (TOF) manner or a phase-shift manner.

The LiDAR 330 may be implemented as a drive type or a non-drive type.

For the drive type, the LiDAR 330 may be rotated by a motor and detect object near the vehicle 100.

For the non-drive type, the LiDAR 330 may detect, through light steering, objects which are located within a predetermined range based on the vehicle 100. The vehicle 100 may include a plurality of non-drive type LiDARs 330.

The LiDAR 330 may detect an object in a TOP manner or a phase-shift manner through the medium of a laser beam, and detect a position of the detected object, a distance from the detected object and a relative speed with the detected object.

The LiDAR 330 may be disposed on an appropriate position outside the vehicle for detecting an object located at the front, rear or side of the vehicle.

The ultrasonic sensor 340 may include ultrasonic wave transmitting and receiving portions. The ultrasonic sensor 340 may detect an object based on an ultrasonic wave, and detect a position of the detected object, a distance from the detected object and a relative speed with the detected object.

The ultrasonic sensor 340 may be disposed on an appropriate position outside the vehicle for detecting an object located at the front, rear or side of the vehicle.

The infrared sensor 350 may include infrared light transmitting and receiving portions. The infrared sensor 340 may detect an object based on infrared light, and detect a position of the detected object, a distance from the detected object and a relative speed with the detected object.

The infrared sensor 350 may be disposed on an appropriate position outside the vehicle for detecting an object located at the front, rear or side of the vehicle.

The processor 370 may control an overall operation of each unit of the object detecting apparatus 300.

The processor 370 may detect an object based on an acquired image, and track the object. The processor 370 may execute operations, such as a calculation of a distance from the object, a calculation of a relative speed with the object and the like, through an image processing algorithm.

The processor 370 may detect an object based on a reflected electromagnetic wave which an emitted electromagnetic wave is reflected from the object, and track the object. The processor 370 may execute operations, such as a calculation of a distance from the object, a calculation of a relative speed with the object and the like, based on the electromagnetic wave.

The processor 370 may detect an object based on a reflected laser beam which an emitted laser beam is reflected from the object, and track the object. The processor 370 may execute operations, such as a calculation of a distance from the object, a calculation of a relative speed with the object and the like, based on the laser beam.

The processor 370 may detect an object based on a reflected ultrasonic wave which an emitted ultrasonic wave is reflected from the object, and track the object. The processor 370 may execute operations, such as a calculation of a distance from the object, a calculation of a relative speed with the object and the like, based on the ultrasonic wave.

The processor may detect an object based on reflected infrared light which emitted infrared light is reflected from the object, and track the object. The processor 370 may execute operations, such as a calculation of a distance from the object, a calculation of a relative speed with the object and the like, based on the infrared light.

According to an embodiment, the object detecting apparatus 300 may include a plurality of processors 370 or may not include any processor 370. For example, each of the camera 310, the radar 320, the LiDAR 330, the ultrasonic sensor 340 and the infrared sensor 350 may include the processor in an individual manner.

When the processor 370 is not included in the object detecting apparatus 300, the object detecting apparatus 300 may operate according to the control of a processor of an apparatus within the vehicle 100 or the controller 170.

The object detecting apparatus 400 may operate according to the control of the controller 170.

The communication apparatus 400 is an apparatus for performing communication with an external device. Here, the external device may be another vehicle, a mobile terminal or a server.

The communication apparatus 400 may perform the communication by including at least one of a transmitting antenna, a receiving antenna, and radio frequency (RF) circuit and RF device for implementing various communication protocols.

The communication apparatus 400 may include a short-range communication unit 410, a location information unit 420, a V2X communication unit 430, an optical communication unit 440, a broadcast transceiver 450 and a processor 470.

According to an embodiment, the communication apparatus 400 may further include other components in addition to the components described, or may not include some of the components described.

The short-range communication unit 410 is a unit for facilitating short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication unit 410 may construct short-range area networks to perform short-range communication between the vehicle 100 and at least one external device.

The location information unit 420 is a unit for acquiring position information. For example, the location information unit 420 may include a Global Positioning System (GPS) module or a Differential Global Positioning System (DGPS) module.

The V2X communication unit 430 is a unit for performing wireless communications with a server (Vehicle to Infra; V2I), another vehicle (Vehicle to Vehicle; V2V), or a pedestrian (Vehicle to Pedestrian; V2P). The V2X communication unit 430 may include an RF circuit implementing a communication protocol with the infra (V2I), a communication protocol between the vehicles (V2V) and a communication protocol with a pedestrian (V2P).

The optical communication unit 440 is a unit for performing communication with an external device through the medium of light. The optical communication unit 440 may include a light-emitting diode for converting an electric signal into an optical signal and sending the optical signal to the exterior, and a photodiode for converting the received optical signal into an electric signal.

According to an embodiment, the light-emitting diode may be integrated with lamps provided on the vehicle 100.

The broadcast transceiver 450 is a unit for receiving a broadcast signal from an external broadcast managing entity or transmitting a broadcast signal to the broadcast managing entity via a broadcast channel. The broadcast channel may include a satellite channel, a terrestrial channel, or both. The broadcast signal may include a TV broadcast signal, a radio broadcast signal and a data broadcast signal.

The processor 470 may control an overall operation of each unit of the communication apparatus 400.

According to an embodiment, the communication apparatus 400 may include a plurality of processors 470 or may not include any processor 470.

When the processor 470 is not included in the communication apparatus 400, the communication apparatus 400 may operate according to the control of a processor of another device within the vehicle 100 or the controller 170.

Meanwhile, the communication apparatus 400 may implement a display apparatus for a vehicle together with the user interface apparatus 200. In this instance, the display apparatus for the vehicle may be referred to as a telematics apparatus or an Audio Video Navigation (AVN) apparatus.

The communication apparatus 400 may operate according to the control of the controller 170.

The driving control apparatus 500 is an apparatus for receiving a user input for driving.

In a manual mode, the vehicle 100 may be operated based on a signal provided by the driving control apparatus 500.

The driving control apparatus 500 may include a steering input device 510, an acceleration input device 530 and a brake input device 570.

The steering input device 510 may receive an input regarding a driving (ongoing) direction of the vehicle 100 from the user. The steering input device 510 is preferably configured in the form of a wheel allowing a steering input in a rotating manner. According to some embodiments, the steering input device may also be configured in a shape of a touch screen, a touch pad or a button.

The acceleration input device 530 may receive an input for accelerating the vehicle 100 from the user. The brake input device 570 may receive an input for braking the vehicle 100 from the user. Each of the acceleration input device 530 and the brake input device 570 is preferably configured in the form of a pedal. According to some embodiments, the acceleration input device or the brake input device may also be configured in a shape of a touch screen, a touch pad or a button.

The driving control apparatus 500 may operate according to the control of the controller 170.

The vehicle operating apparatus 600 is an apparatus for electrically controlling operations of various devices within the vehicle 100.

The vehicle operating apparatus 600 may include a power train operating unit 610, a chassis operating unit 620, a door/window operating unit 630, a safety apparatus operating unit 640, a lamp operating unit 650, and an air-conditioner operating unit 660.

According to some embodiments, the vehicle operating apparatus 600 may further include other components in addition to the components described, or may not include some of the components described.

Meanwhile, the vehicle operating apparatus 600 may include a processor. Each unit of the vehicle operating apparatus 600 may individually include a processor.

The power train operating unit 610 may control an operation of a power train device.

The power train operating unit 610 may include a power source operating portion 611 and a gearbox operating portion 612.

The power source operating portion 611 may perform a control for a power source of the vehicle 100.

For example, upon using a fossil fuel-based engine as the power source, the power source operating portion 611 may perform an electronic control for the engine. Accordingly, an output torque and the like of the engine can be controlled. The power source operating portion 611 may adjust the engine output torque according to the control of the controller 170.

For example, upon using an electric energy-based motor as the power source, the power source operating portion 611 may perform a control for the motor. The power source operating portion 611 may adjust a rotating speed, a torque and the like of the motor according to the control of the controller 170.

The gearbox operating portion 612 may perform a control for a gearbox.

The gearbox operating portion 612 may adjust a state of the gearbox. The gearbox operating portion 612 may change the state of the gearbox into drive (forward) (D), reverse (R), neutral (N) or parking (P).

Meanwhile, when an engine is the power source, the gearbox operating portion 612 may adjust a locked state of a gear in the drive (D) state.

The chassis operating unit 620 may control an operation of a chassis device.

The chassis operating unit 620 may include a steering operating portion 621, a brake operating portion 622 and a suspension operating portion 623.

The steering operating portion 621 may perform an electronic control for a steering apparatus within the vehicle 100. The steering operating portion 621 may change a driving direction of the vehicle.

The brake operating portion 622 may perform an electronic control for a brake apparatus within the vehicle 100. For example, the brake operating portion 622 may control an operation of brakes provided at wheels to reduce speed of the vehicle 100.

Meanwhile, the brake operating portion 622 may individually control each of a plurality of brakes. The brake operating portion 622 may differently control braking force applied to each of a plurality of wheels.

The suspension operating portion 623 may perform an electronic control for a suspension apparatus within the vehicle 100. For example, the suspension operating portion 623 may control the suspension apparatus to reduce vibration of the vehicle 100 when a bump is present on a road.

Meanwhile, the suspension operating portion 623 may individually control each of a plurality of suspensions.

The door/window operating unit 630 may perform an electronic control for a door apparatus or a window apparatus within the vehicle 100.

The door/window operating unit 630 may include a door operating portion 631 and a window operating portion 632.

The door operating portion 631 may perform the control for the door apparatus. The door operating portion 631 may control opening or closing of a plurality of doors of the vehicle 100. The door operating portion 631 may control opening or closing of a trunk or a tail gate. The door operating portion 631 may control opening or closing of a sunroof.

The window operating portion 632 may perform the electronic control for the window apparatus. The window operating portion 632 may control opening or closing of a plurality of windows of the vehicle 100.

The safety apparatus operating unit 640 may perform an electronic control for various safety apparatuses within the vehicle 100.

The safety apparatus operating unit 640 may include an airbag operating portion 641, a seatbelt operating portion 642 and a pedestrian protecting apparatus operating portion 643.

The airbag operating portion 641 may perform an electronic control for an airbag apparatus within the vehicle 100. For example, the airbag operating portion 641 may control the airbag to be deployed upon a detection of a risk.

The seatbelt operating portion 642 may perform an electronic control for a seatbelt apparatus within the vehicle 100. For example, the seatbelt operating portion 642 may control passengers to be motionlessly seated in seats 110FL, 110FR, 110RL, 110RR using seatbelts upon a detection of a risk.

The pedestrian protecting apparatus operating portion 643 may perform an electronic control for a hood lift and a pedestrian airbag. For example, the pedestrian protecting apparatus operating portion 643 may control the hood lift and the pedestrian airbag to be open up upon detecting pedestrian collision.

The lamp operating unit 650 may perform an electronic control for various lamp apparatuses within the vehicle 100.

The air-conditioner operating unit 660 may perform an electronic control for an air conditioner within the vehicle 100. For example, the air-conditioner operating unit 660 may control the air conditioner to supply cold air into the vehicle when internal temperature of the vehicle is high.

The vehicle operating apparatus 600 may include a processor. Each unit of the vehicle operating apparatus 600 may individually include a processor.

The vehicle operating apparatus 600 may operate according to the control of the controller 170.

The operation system 700 is a system that controls various driving modes of the vehicle 100. The operation system 700 may operate in an autonomous driving mode.

The operation system 700 may include a driving system 710, a parking exit system 740 and a parking system 750.

According to embodiments, the operation system 700 may further include other components in addition to components to be described, or may not include some of the components to be described.

Meanwhile, the operation system 700 may include a processor. Each unit of the operation system 700 may individually include a processor.

According to embodiments, the operation system may be a sub concept of the controller 170 when it is implemented in a software configuration.

Meanwhile, according to embodiment, the operation system 700 may be a concept including at least one of the user interface apparatus 200, the object detecting apparatus 300, the communication apparatus 400, the vehicle operating apparatus 600 and the controller 170.

The driving system 710 may perform driving of the vehicle 100.

The driving system 710 may receive navigation information from a navigation system 770, transmit a control signal to the vehicle operating apparatus 600, and perform driving of the vehicle 100.

The driving system 710 may receive object information from the object detecting apparatus 300, transmit a control signal to the vehicle operating apparatus 600 and perform driving of the vehicle 100.

The driving system 710 may receive a signal from an external device through the communication apparatus 400, transmit a control signal to the vehicle operating apparatus 600, and perform driving of the vehicle 100.

The parking exit system 740 may perform an exit of the vehicle 100 from a parking lot.

The parking exit system 740 may receive navigation information from the navigation system 770, transmit a control signal to the vehicle operating apparatus 600, and perform the exit of the vehicle 100 from the parking lot.

The parking exit system 740 may receive object information from the object detecting apparatus 300, transmit a control signal to the vehicle operating apparatus 600 and perform the exit of the vehicle 100 from the parking lot.

The parking exit system 740 may receive a signal from an external device through the communication apparatus 400, transmit a control signal to the vehicle operating apparatus 600, and perform the exit of the vehicle 100 from the parking lot.

The parking system 750 may perform parking of the vehicle 100.

The parking system 750 may receive navigation information from the navigation system 770, transmit a control signal to the vehicle operating apparatus 600, and park the vehicle 100.

The parking system 750 may receive object information from the object detecting apparatus 300, transmit a control signal to the vehicle operating apparatus 600 and park the vehicle 100.

The parking system 750 may receive a signal from an external device through the communication apparatus 400, transmit a control signal to the vehicle operating apparatus 600, and park the vehicle 100.

The navigation system 770 may provide navigation information. The navigation information may include at least one of map information, information regarding a set destination, path information according to the set destination, information regarding various objects on a path, lane information and current location information of the vehicle.

The navigation system 770 may include a memory and a processor. The memory may store the navigation information. The processor may control an operation of the navigation system 770.

According to embodiments, the navigation system 770 may update prestored information by receiving information from an external device through the communication apparatus 400.

According to embodiments, the navigation system 770 may be classified as a sub component of the user interface apparatus 200.

The sensing unit 120 may sense a status of the vehicle. The sensing unit 120 may include a posture sensor (e.g., a yaw sensor, a roll sensor, a pitch sensor, etc.), a collision sensor, a wheel sensor, a speed sensor, a tilt sensor, a weight-detecting sensor, a heading sensor, a gyro sensor, a position module, a vehicle forward/backward movement sensor, a battery sensor, a fuel sensor, a tire sensor, a steering sensor by a turn of a handle, a vehicle internal temperature sensor, a vehicle internal humidity sensor, an ultrasonic sensor, an illumination sensor, an accelerator position sensor, a brake pedal position sensor, and the like.

The sensing unit 120 may acquire sensing signals with respect to vehicle-related information, such as a posture, a collision, an orientation, a position (GPS information), an angle, a speed, an acceleration, a tilt, a forward/backward movement, a battery, a fuel, tires, lamps, internal temperature, internal humidity, a rotated angle of a steering wheel, external illumination, pressure applied to an accelerator, pressure applied to a brake pedal and the like.

The sensing unit 120 may further include an accelerator sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), and the like.

The interface unit 130 may serve as a path allowing the vehicle 100 to interface with various types of external devices connected thereto. For example, the interface unit 130 may be provided with a port connectable with a mobile terminal, and connected to the mobile terminal through the port. In this instance, the interface unit 130 may exchange data with the mobile terminal.

Meanwhile, the interface unit 130 may serve as a path for supplying electric energy to the connected mobile terminal. When the mobile terminal is electrically connected to the interface unit 130, the interface unit 130 supplies electric energy supplied from a power supply unit 190 to the mobile terminal according to the control of the controller 170.

The memory 140 is electrically connected to the controller 170. The memory 140 may store basic data for units, control data for controlling operations of units and input/output data. The memory 140 may be a variety of storage devices, such as ROM, RAM, EPROM, a flash drive, a hard drive and the like in a hardware configuration. The memory 140 may store various data for overall operations of the vehicle 100, such as programs for processing or controlling the controller 170.

According to embodiments, the memory 140 may be integrated with the controller 170 or implemented as a sub component of the controller 170.

The controller 170 may control an overall operation of each unit of the vehicle 100. The controller 170 may be referred to as an Electronic Control Unit (ECU).

The power supply unit 190 may supply power required for an operation of each component according to the control of the controller 170. Specifically, the power supply unit 190 may receive power supplied from an internal battery of the vehicle, and the like.

At least one processor and the controller 170 included in the vehicle 100 may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro controllers, microprocessors, and electric units performing other functions.

Meanwhile, the vehicle 100 according to the present invention may include a vehicle control device 800.

The vehicle control device 800 may control at least one of those components illustrated in FIG. 7. From this perspective, the vehicle control device 800 may be the controller 170.

Without a limit to this, the vehicle control device 800 may be a separate device, independent of the controller 170. When the vehicle control device 800 is implemented as a component independent of the controller 170, the vehicle control device 800 may be provided on a part of the vehicle 100.

Hereinafter, description will be given of an example that the vehicle control device 800 is a component separate from the controller 170 for the sake of explanation. In this specification, functions (operations) and control methods described in relation to the vehicle control device 800 may be executed by the controller 170 of the vehicle. That is, every detail described in relation to the vehicle control device 800 may be applied to the controller 170 in the same/like manner.

Also, the vehicle control device 800 described herein may include some of the components illustrated in FIG. 7 and various components included in the vehicle. For the sake of explanation, the components illustrated in FIG. 7 and the various components included in the vehicle will be described with separate names and reference numbers.

Hereinafter, the components included in a vehicle control device 800 according to an embodiment of the present invention will be described in detail with reference to the accompanying drawings.

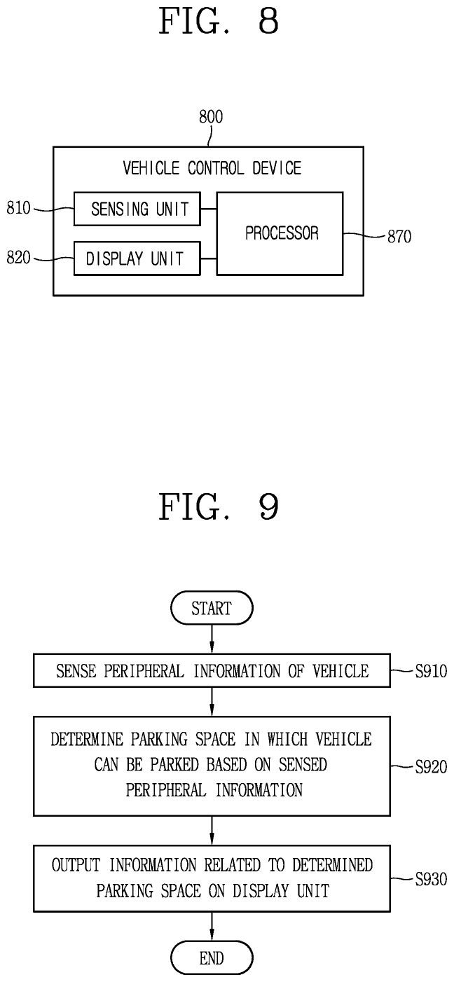

FIG. 8 is a conceptual diagram for explaining a vehicle control device according to an embodiment of the present invention.

Meanwhile, the vehicle control device 800 related to the present invention may include a sensing unit 810, a display unit 820, a processor 870, and the like.

The sensing unit 810 may be the object detecting device 300 described with reference to FIG. 7 or the sensing unit 120 provided in the vehicle 100.

In addition, the sensing unit 810 may be a separate sensing unit independent from the object detecting device 300 or the sensing unit 120 provided in the vehicle 100. The sensing unit 830 may include the characteristics of the sensing unit 120 or the object device 300 described with reference to FIG. 7, even when the sensing unit 810 is an independent sensing unit.

The sensing unit 810 may include the camera 310 described with reference to FIG. 7.

The sensing unit 810 may be implemented by combining at least two of a camera 310, a radar 320, a lidar 330, an ultrasonic sensor 340, an infrared sensor 350, and the sensing unit 120.

The sensing unit 810 may sense an object existing in the vicinity of the vehicle 100 and sense information related to the object.

For example, the object may include the above-mentioned nearby vehicles, nearby people, surrounding objects, surrounding geographical features, and the like.

The sensing unit 810 may sense information related to the vehicle 100 of the present invention.

The information related to the vehicle may be at least one of vehicle information (or a running state of the vehicle) and peripheral information of the vehicle.

For example, the vehicle information may include a running speed of the vehicle, a weight of the vehicle, a number of passengers of the vehicle, a braking force of the vehicle, a maximum braking force of the vehicle, a running mode (whether the vehicle is in an autonomous mode or a manual mode), a parking mode (autonomous parking mode, automatic parking mode, manual parking mode), whether or not the user is aboard the vehicle, and information related to the user (for example, whether or not the user is an authenticated user).

The peripheral information of the vehicle includes, for example, a state of a road surface (friction force) on which the vehicle is running, weather, a distance to a front (or rear) vehicle, a relative speed of the front (or rear) vehicle, a curvature of a curve when a lane in which the vehicle is running is the curve, a brightness around the vehicle, information related to an object existing in a reference area (a preset area) based on the vehicle, whether the object enters/leaves the preset area, whether a user exists around the vehicle, information related to the user (e.g., whether the user is an authenticated user), and the like.

The peripheral information (or the surrounding environment information) of the vehicle may include external information of the vehicle (for example, a surrounding brightness, a temperature, a location of the sun, a surrounding subject (person, another vehicle, signboard, etc.), a type of a road surface on which the vehicle is running, geographic features, line information, running lane information, and information necessary for autonomous driving/autonomous parking/automatic parking/manual parking mode.

In addition, the peripheral information of the vehicle may further include a distance from an object existing in the vicinity of the vehicle to the vehicle 100, a type of the object, a parking space available for the vehicle to park, an object for identifying a parking space (for example, a parking line, string, different vehicle, wall, etc.)

Hereinafter, for the sake of convenience of explanation, one example in which the sensing unit 810 is separately provided in the vehicle control device 800 will be described. Acquiring certain information by the processor 870 through the sensing unit 810 may be understood as acquiring by the processor 870 certain information by using the at least one of the object detecting device 300 and the sensing unit 120 provided in the vehicle 100.

The vehicle control device 800 of the present invention may include a display unit 820.

The display unit 820 may be the output unit 250 and the display unit 251 shown in FIG. 7. Also, the display unit 820 may include an output unit (e.g., a touch screen) of a mobile terminal that can communicate with the communication device 400.

As described above, the display unit 820 may be implemented as a head up display (HUD).

In addition, the display unit 820 may include a transparent display. The transparent display may be attached to the windshield or window.

The display unit 820 may be implemented in one area of the steering wheel, one area 251a, 251b, and 251e of the inspiration panel, one area 251d of the sheet, one area 251f of each filler, one area 251g of the door, one area of the center console, one area of the head lining, one area of the sun visor, one area 251c of the windshield, and one area 251h of the window.

The vehicle control device 800 of the present invention may include a processor 870 capable of controlling the sensing unit 810, the display unit 820, and the like.

The processor 870 may be the controller 170 described with reference to FIG. 7.

The processor 870 may control the components described in FIG. 7 and the components described in FIG. 8.

The processor 870 included in the vehicle control device 800 related to the present invention may control the sensing unit 810 to sense the peripheral information of the vehicle 100.

In addition, the processor 870 may determine a parking space in which the vehicle 100 can be parked based on the sensed peripheral information, and output information related to the determined parking space on the display unit 820.

That is, the processor 870 may control the display unit 820 to output information related to the determined parking space.

In addition, the processor 870 may output the information related to the parking space on the display unit 820 in different manners based on a type of a road on which the vehicle 100 is located.

Hereinafter, a method of providing information related to a parking space in which the vehicle can be parked to a user in various manners will be described in more detail with reference to the accompanying drawings.

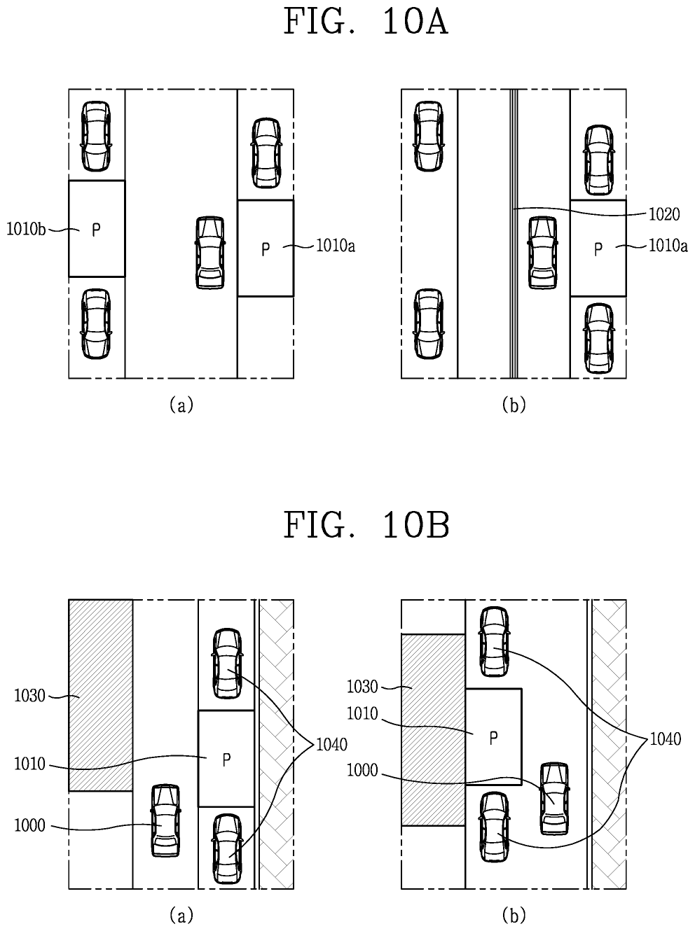

FIG. 9 is a flowchart for explaining a typical control method of the present invention, and FIGS. 10A, 10B, 11A, 11B, 11C and 12 are conceptual diagrams for explaining the control method shown in FIG. 9.

In addition, all the contents described below may be applied selectively in a manual parking mode, an automatic parking mode, and an autonomous parking mode.

The manual parking mode may mean a mode in which parking is performed by an operation of the driver.

The automatic parking mode may be a mode in which a vehicle automatically performs parking to a corresponding parking space according to a preset algorithm by a user setting from the surroundings of the parking space in which the vehicle 100 can be parked.

The autonomous parking mode may mean a mode in which the vehicle 100 may automatically detect or search for a parking space in which the vehicle can be parked, move to the corresponding parking space, and perform automatic parking.

Referring to FIG. 9, in the present invention, peripheral information of the vehicle 100 is sensed (S910).

The sensing unit 810 may sense information related to an area included within a certain distance from the present vehicle 100 (i.e., peripheral information of the vehicle). Specifically, the processor 870 may control the sensing unit 810 to sense the peripheral information of the vehicle.

For example, the processor 870 may control the sensing unit 810 to sense the peripheral information of the vehicle based on whether the vehicle 100 satisfies preset conditions. For example, the preset condition may be include a condition that a user input (e.g., selection of a button associated with a function of searching for a parking space) is received, a condition that the vehicle 100 enters within a certain distance from the parking space in which the vehicle can be parked, a condition that the vehicle 100 is running in a preset lane (for example, an edge lane), or a condition that a running speed of the vehicle 100 is a constant speed or lower.

As another example, the processor 870 may control the sensing unit 810 to periodically or continuously sense the peripheral information of the vehicle.

In one example, the peripheral information of the vehicle may include a distance from an object existing in the vicinity of the vehicle to the vehicle 100, a type of the object, a parking space in which the vehicle can be parked, an object for identifying a parking space (for example, a parking line, a string, another vehicle, a wall, etc.).

In order to sense the peripheral information of the vehicle, anyone of the camera 310, the radar 320, the lidar 330, the ultrasonic sensor 340, the infrared sensor 350, and the sensing unit 120 or a combination of at least two of them may be used.

Thereafter, in the present invention, a parking space in which the vehicle can be parked is determined based on the sensed peripheral information (S920).

The processor 870 may determine the parking space in which the vehicle can be parked based on the peripheral information of the vehicle 100 sensed through the sensing unit 810.

The processor 870 may determine (sense, determining, detect, extract) a parking space in which the vehicle can be parked when the preset condition is satisfied.

The preset condition herein may mean a condition that the vehicle is determined to be parked and may be related to at least one of a speed of the vehicle 100, a location of the vehicle, a gear state, and a surrounding environment.

For example, the processor 870 may perform sensing on the parking space if the speed of the vehicle 100 is below a certain speed or if the location of the vehicle is within an area available for parking (for example, a parking lot, etc.).

As another example, the processor 870 may perform sensing on the parking space when the vehicle enters the autonomous parking mode or the automatic parking mode or when a gear of the vehicle is changed from a forward gear to a reverse gear by the user.

As another example, the processor 870 may perform sensing of the parking space when the surrounding environment sensed through the sensing unit 810 (for example, camera) is an area available for parking.

The processor 870 may determine (sense, detect, and extract) a parking space available for parking in various manners.

The processor 870 may sense a parking line through the sensing unit 810 and may determine a space as a parking space available for parking if it is determined that it is possible to park in the space inside the parking line.

As another example, the processor 870 may sense at least one different vehicle through the sensing unit 810, and when it is determined that the present vehicle 100 can be parked in a space spaced apart from the sensed different vehicle by a predetermined distance, the processor 870 may sense the corresponding space as a parking space.

In one example, the processor 870 may determine whether or not the corresponding space is available for parking based on a size (width, length) of the vehicle and the sensed space.

For example, the processor 870 may compare the preset distance with the length required for parking the present vehicle (e.g., the length of the vehicle body and a preset clearance length of the vehicle 100).

Thereafter, the processor 870 may determine the space as a parking space in which the vehicle 100 can be parked if the preset distance is longer than the length.

Alternatively, if the preset distance is longer than the length and the width of the space is longer than the sum of the width of the vehicle body of the vehicle 100 and the preset clearance length, the processor 870 may determine the space as a parking space in which the present vehicle 100 can be parked.

Thereafter, in the present invention, information related to the determined parking space is output on the display unit 820 (S930).

Specifically, the processor 870 may control the display unit 820 to output the information related to the determined parking space. At this time, the processor 870 may implement the information related to the parking space in a preset graphical interface and output the information on the display unit 820.

The information related to the parking space output on the display unit 820 may include a graphic object corresponding to the vehicle 100, a graphic object indicating the space available for parking, and a graphic object corresponding to objects existing within a preset distance from the vehicle 100, a graphic object corresponding to a road, and the like.

Meanwhile, the processor 870 may output the information related to the parking space on the display unit 820 in different manners based on the type of the road on which the vehicle 100 is located.

Here, the type of the road may be, for example, a one-way road or a two-way road. In addition, the type of the road may include a kind of road surface (for example, whether it is a dirt road or an asphalt road). In this specification, for convenience of explanation, the types of roads include a one-way road and a two-way road, for example.

The processor 870 may output information related to the parking space detected on the left and right sides of the vehicle on the display unit 820 if the type of the road on which the vehicle 100 is located is a first type.

In addition, if the type of the road on which the vehicle 100 is located is a second type different from the first type, the processor 870 may output information related to the parking space detected from any one of the left and right sides of the vehicle on the display unit 820.

Here, the processor 870 may output, on the display unit, information related to a parking space existing in a direction opposite to a direction in which a center line of the left and right sides of the vehicle 100 is detected in the second type road.

Referring to FIG. 10A, when the type of road on which the vehicle 100 is located is the first type (for example, one-way road) as shown in (a) of FIG. 10A, the display unit 820 may control the display unit 820 to output all the information 1010a and 1010b related to the parking space detected on the left and right sides of the parking space.

Meanwhile, if the road on which the vehicle 100 is located is the second type (for example, two-way road) as shown in (b) of FIG. 10A, the processor 870 may control the display unit 820 to output only the information 1010a related to the parking space detected from any one of them.

Here, any one of the left and right sides may be determined by a passage direction.

For example, when a vehicle passage direction in a country (or a state) where the present vehicle 100 is running is a right passage direction, the processor 870 may output only information related to a parking space detected on the right side of the vehicle on the display unit 820.

In another example, when a vehicle passage direction in a country (or a state) where the present vehicle 100 is running is a left passage direction, the processor 870 may display only the information related to a parking space detected on the left side of the vehicle on the display unit 820.

Whether the vehicle passage direction is the left or right passage direction may be determined based on a location of the center line.

For example, when the center line 1020 is detected on the left side of the vehicle, the passage direction of the corresponding country (or state) becomes the rightward traveling direction.

As another example, if the center line 1020 is detected on the right side of the vehicle 100, the passage direction of the country (or state) is the left passage direction.

Accordingly, the processor 870 may output information 1010a related to the parking space existing in the direction opposite to the direction in which the center line 1020 of the left and right sides of the vehicle is detected, on the second type road (two-way passage road) on the display unit 820.

That is, as shown in (b) of FIG. 10A, when the center line 1020 sensed by the sensing unit 810 exists on the left side of the vehicle 100, the road is a right passage road, and thus, the processor 870 may output only the information 1010a related to the parking space existing on the right side opposite to the left side on the display unit 820.

Although not shown, when the center line 1020 sensed by the sensing unit 810 exists on the right side of the vehicle 100, the road is a left passage road, and thus, the processor 870 may output information related to the parking space existing on the left side opposite to the right side on the display unit 820.

Meanwhile, the processor 870 may determine a parking space based on the other previously parked vehicle when there is a building around the road where the vehicle exists (or an area adjacent to the road).

For example, as shown in (a) of FIG. 10B, when a building is detected on the left side of the vehicle through the sensing unit 820 and the other previously parked vehicle is detected on the right side of the vehicle 100, the processor 870 may sense a parking space existing on the right side of the present vehicle. Thereafter, the processor 870 may output the information 1010 related to the parking space existing on the right side of the present vehicle on the display unit 820.

That is, when there is a vehicle or a building to which a user has to go in or out within a certain distance based on the present vehicle 100, the processor 870 may determine a direction in which the vehicle can be parked on the basis of the other previously parked vehicle.

As another example, as shown in (b) of FIG. 10B, when a building is detected on the left side of the vehicle through the sensing unit 820 and the other previously parked vehicle is detected on the left side of the vehicle 100, the processor 870 may sense a parking space existing on the left side of the vehicle 100. Thereafter, the processor 870 may output the information 1010 related to the parking space existing on the left side of the vehicle on the display unit 820.

A graphic object 1030 corresponding to the building, a graphic object 1000 corresponding to the vehicle, and a graphic object 1040 corresponding to the other previously parked vehicle may be displayed on the display unit 820.

In the case of (b) of FIG. 10B, although a building exists on the left side of the vehicle, the other vehicle is already parked on the left side of the vehicle, and thus, the processor 870 may determine that it is possible to park on the left side of the vehicle. Therefore, even though the building exists on the left side of the vehicle, since the previously parked vehicle is detected on the left side of the vehicle, the processor 870 may sense the parking space available for parking on the left side of the vehicle 100.

Meanwhile, when preset information is sensed in the parking space, the processor 870 may determine that the corresponding parking space is a parking prohibited area.

Specifically, although a parking space physically available for parking is sensed through the sensing unit 810, if preset information is sensed in the parking space, the processor 870 may determined the parking space as a parking prohibited space. Here, the preset information may be information for prohibiting parking, an object, or information indicating an attribute different from that of the present vehicle.

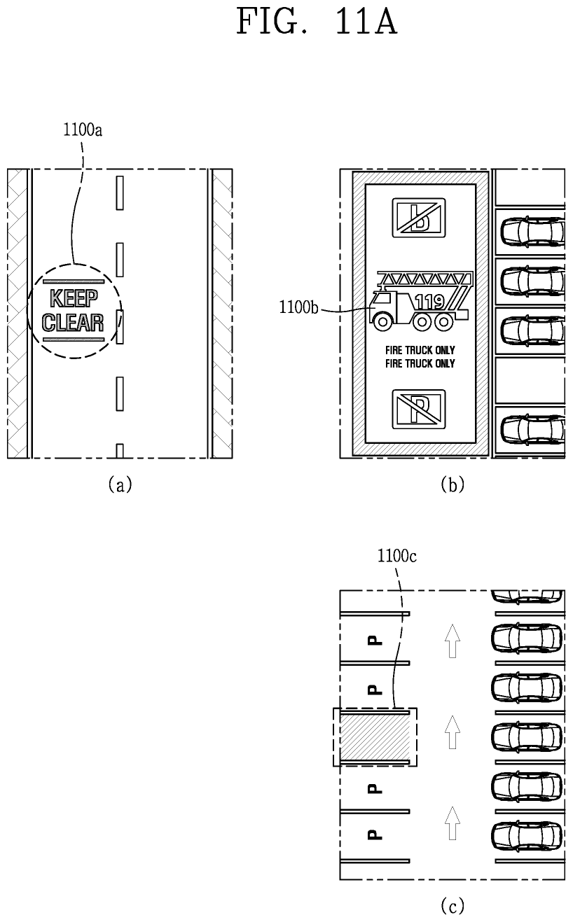

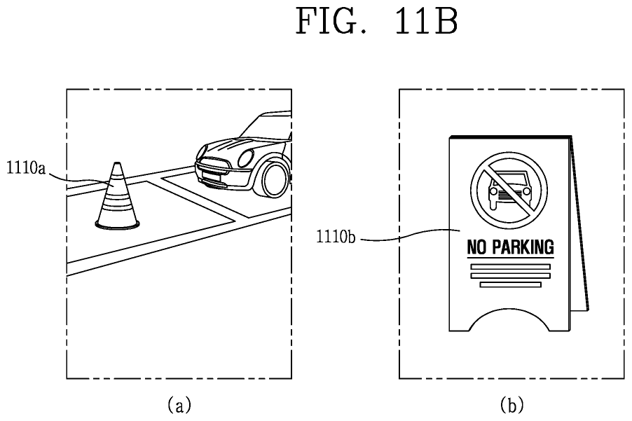

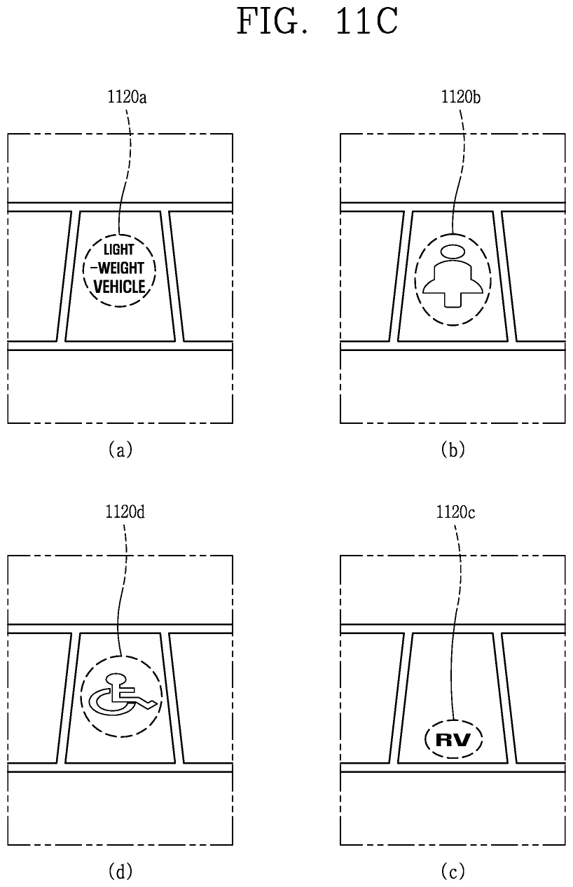

For example, as shown in (a) to (c) of FIG. 11A, when text 1100a or an image 1100b for inhibiting parking is sensed or the oblique line 1100c is sensed in the sensed parking space, the processor 870 may determine (sense, extract, detect) that parking is prohibited in the parking space.

As another example, as shown in (a) and (b) of FIG. 11B, when an object (e.g., parking cone 1110a or sign 1110b) prohibiting parking within (or around) the sensed parking space, the processor 870 may determine (sense, extract, detect) that the parking space is a space in which parking is prohibited.

As another example, as illustrated in (a) to (d) of FIG. 11C, when information indicating an attribute different from the attribute of the present vehicle is sensed in the parking space (for example, when the vehicle is not a light-weight vehicle but information 1120a indicating a light-weight vehicle parking space is sensed, when the driver of the present vehicle is not female but information 1120b indicating a female exclusive parking space is sensed, when the vehicle 100 is not an RV vehicle but information 1120c indicating an exclusive RV parking space is sensed, and when the driver of the present vehicle is not the handicapped but information 1120d indicating a handicapped exclusive parking space is sensed), the processor 870 may determine (sense, extract, detect) the corresponding parking space is a space in which parking is prohibited.

In this case, the processor 870 may output, on the display unit, the parking space available for parking and the space in which parking is prohibited such that they are visually distinguished from each other.

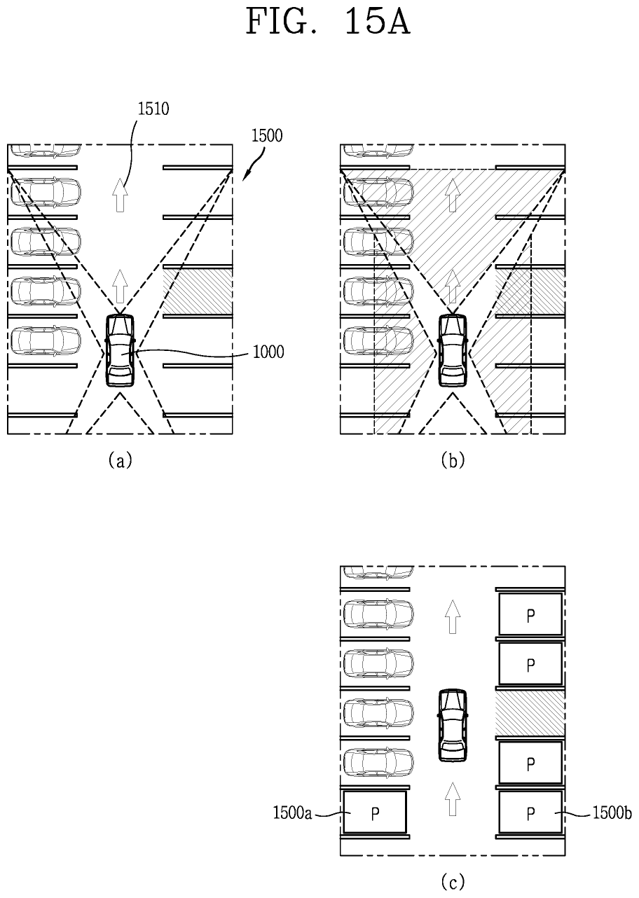

For example, as shown in (b) of FIG. 14B, the processor 870 may output a graphical object 1400b indicating the parking space available for parking and a graphical object 1410a indicating the space in which parking is prohibited such that they are distinguished from each other.

In one example, the processor 870 may apply different graphic effects to the parking space available for parking and the space in which parking is prohibited (or graphical objects that represent them) and output the parking space and the prohibited space (or graphical objects representing them) on the display unit 820 so that they are visually distinguished from each other.

As another example, the processor 870 may output additional graphic objects to the parking space available for parking and the space in which parking is prohibited (or graphical objects that represent them) on the display unit 820 so that the parking space and the prohibited space can be visually distinguished from each other.

Meanwhile, when the lane in which the vehicle 100 is running is a preset lane, the processor 870 may output information related to the parking space on the display unit 820.

When the lane in which the vehicle 100 is running is not the preset lane, the processor 870 may output information (or information indicating that it is not possible to park) indicating that the vehicle is in a lane in which parking is impossible, on the display unit 820.

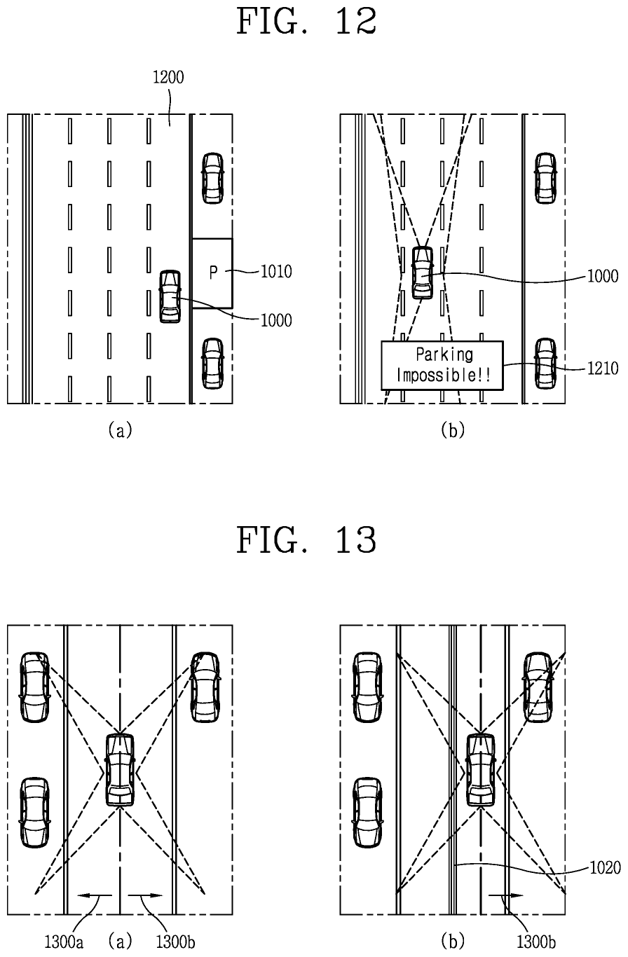

Referring to FIG. 12, the preset lane may be, for example, a lane located at the farthest edge with respect to the center line, a lane where the other vehicle is previously parked, or a side lane of the lane where the other previously parked vehicle exists.

As shown in (a) of FIG. 12A, when the lane in which the vehicle is running is the preset lane (for example, a lane located at the farthest edge with respect to the center line, a lane where the other vehicle is previously parked, or a side lane of the lane where the other previously parked vehicle exists), the processor 870 may determine whether a parking space using the sensing unit 810 and control the display unit 820 to output information 1010 related to the determined parking space.

Meanwhile, as shown in (b) of FIG. 12, when the lane in which the vehicle 100 is running is not the preset lane, the processor 870 may control the display unit 820 to output information 1210 indicating that parking is impossible in the lane.

Through this configuration, the present invention may provide a new user interface that may inform the user about information required for parking in an optimized manner according to the type of road and the lane.

Meanwhile, in the present invention, the sensing unit 810 may be controlled in an optimized manner to determine a parking space. Hereinafter, various methods of controlling the sensing unit to sense a parking space will be described in more detail with reference to the accompanying drawings.

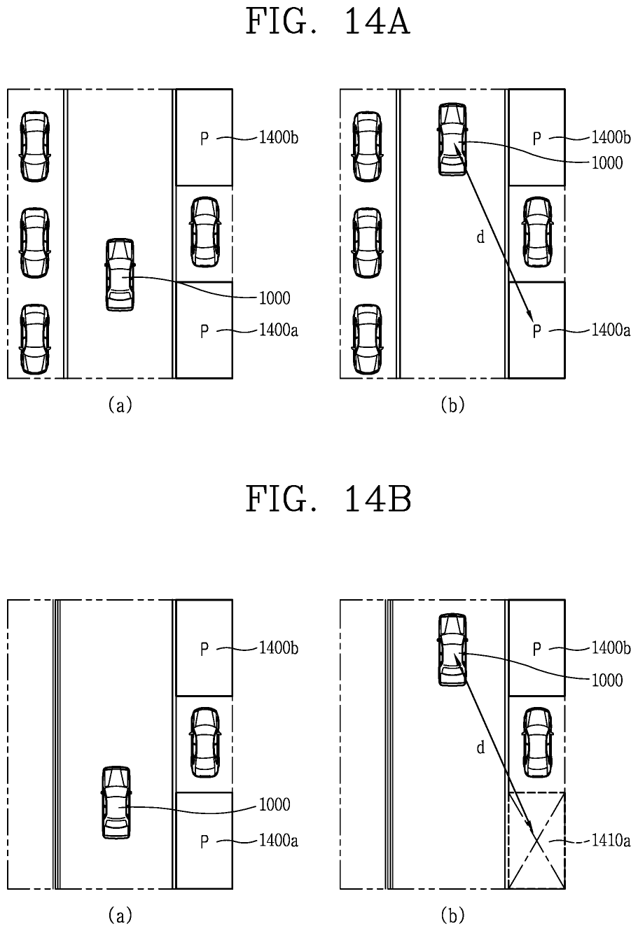

FIGS. 13, 14A, 14B, 15A, 15B, 15C and 15D are conceptual diagrams for explaining various embodiments of the present invention.

Referring to FIG. 13, the processor 870 of the vehicle control device 800 of the present invention may control the sensing unit 810 to sense peripheral information (peripheral information of the vehicle) required for (used in) determining a parking space available for parking in different areas (spaces) based on the type of the road on which the vehicle 100 is located.

For example, as shown in (a) of FIG. 13, if the road on which the vehicle is located is a first type road (for example, a one-way road), the processor 870 may sense the peripheral information (peripheral information of the vehicle) in the left area (left space) 1300a and the right area (right space) 1300b of the vehicle 100.

In another example, as shown in (b) of FIG. 13, if the road on which the vehicle is located is a second type road (e.g., a two-way road) different from the first type road, the processor 870 may sense the peripheral information only in any one of the left area 1300a and the right area 1300b.

For example, if the road on which the vehicle 100 is located is the second type road, the processor 870 may control the sensing unit 810 to sense the peripheral information in an area in which the center line is not included, among the left area 1300a and the right area 1300b.

If the road on which the vehicle is located is the second type road (e.g., two-way road), the processor 870 may sense the center line in any one of the left and right areas of the vehicle 100.

If the road on which the vehicle is located is a right passage road, the processor 870 may sense the center line in the left area of the vehicle through the sensing unit 810. In this case, the processor 870 may control the sensing unit 810 to sense the peripheral information of the vehicle used to determine a parking space in the area (right area) in which the center line is not included.

Conversely, if the road on which the vehicle is located is a left passage road, the processor 870 may sense the center line in the right area of the vehicle through the sensing unit 810. In this case, the processor 870 may control the sensing unit 810 to sense the peripheral information of the vehicle used to determine a parking space in the area (left area) in which the center line is not included.

Even when the sensing unit 810 senses a front area and a rear area, the above contents may be inferred and applied in the same or similar manner. For example, when the sensing unit 810 is controlled by the processor 870 to sense the peripheral information of the vehicle in the left area of the vehicle 100, the processor 870 may control the sensing unit 810 to sense the peripheral information in the left area, the front left area and the rear left area.

As another example, when the sensing unit 810 is controlled by the processor 870 to sense the peripheral information of the vehicle in the right area of the vehicle 100, the sensing unit 810 may sense the peripheral information in the right area, the front right area and the rear right area.

In the above, it is described that the sensing unit senses at least one of the left area and the right area, but the present invention is not limited thereto. The above contents may be inferred and applied in the same or similar manner when the sensing unit senses at least one of the front area and the rear area.

Meanwhile, when the vehicle 100 passes by a specific point based on the parking space available for parking, the processor 870 may change the information related to the parking space output on the display unit 820 from a space available for parking to a space unavailable for parking.

At this time, the specific point may be different depending on the type of road on which the vehicle is located.

The specific point may be determined by a distance between the vehicles at one point of the space available for parking. For example, the specific point may be a point spaced apart from one point of the space available for parking by a predetermined distance d.

For example, as shown in (a) and (b) of FIG. 14A, when the type of the road on which the vehicle exists is the first type road (for example, one-way road), the processor 870, even though the vehicle 100 passes by a specific point based on the parking space 1400a available for parking (is spaced apart by a predetermined distance d from the corresponding parking space 1400a), the processor 870 may maintain the parking space 1400a as a space available for parking.

As another example, as shown in (a) and (b) of FIG. 14, when the type of the road on which the vehicle exists is the second type road (for example, two-way passage road) different from the first type road, the processor 870, if the vehicle 100 passes by the specific point based on the parking space 1400a available for parking(is spaced apart by the predetermined distance d from the corresponding parking space 1400a), the processor 870 may change the corresponding parking space 1400a from the space available for parking to a space 1410 unavailable for parking.

In this case, in the display unit 820, the space 1410a unavailable for parking and the spaces 1400a and 1400b available for parking may be displayed to be visually distinguished from each other.

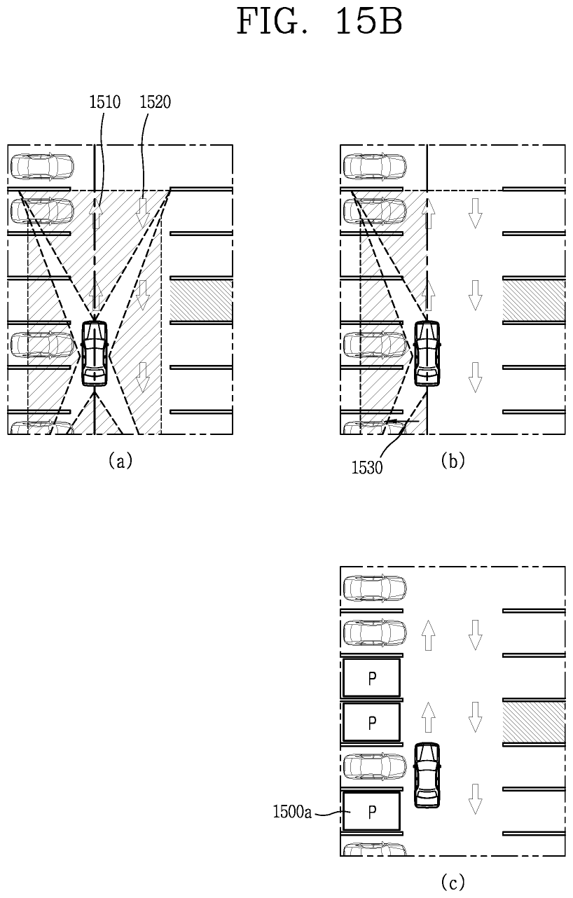

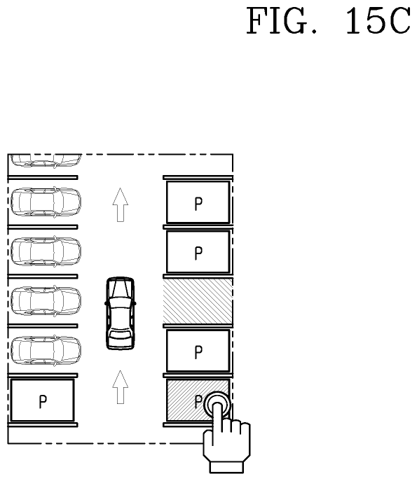

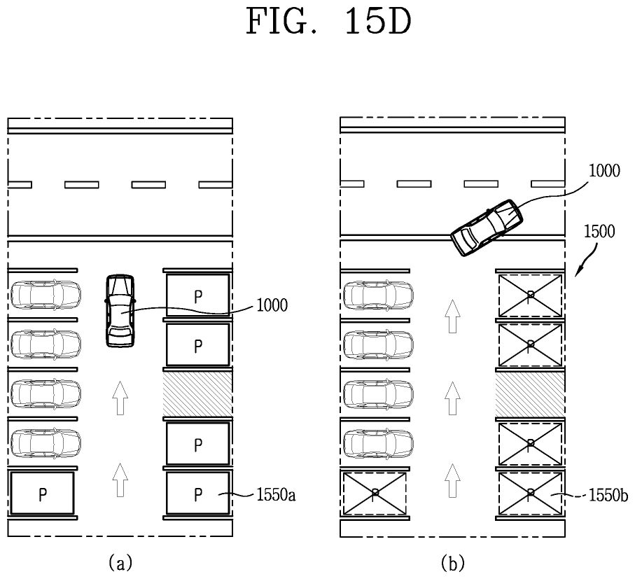

FIGS. 15A to 15D show a method of controlling a vehicle in a parking lot.

When the vehicle 100 is located in a parking lot 1500, the processor 870 may output a parking space available for parking on the display unit 820 in different manners according to whether a corresponding parking passage is a one-way road or a two-way road.

For example, as shown in FIG. 15A, the processor 870 may determine whether the present vehicle has entered the parking lot using a location information unit 420 or a separate location module.

The processor 870 may sense information 1510 written in a parking passage in which the vehicle 100 is located in the parking lot using the sensing unit 820. The processor 870 may determine whether the corresponding parking passage is a one-way road or two-way road using the sensed information 1510.

Thereafter, the processor 870 may output information related to the parking space available for parking on the display unit 820 in different manners based on whether the corresponding parking passage is one-way road or two-way road.

For example, as shown in (a) of FIG. 15A, the processor 870 may determine that the corresponding parking passage is a one-way road based on the information 1510 written in the parking passage. In this case, as shown in (b) of FIG. 15A, the processor 870 may sense peripheral information of the vehicle (used) required for determining the parking space for both the left area and the right area of the vehicle.

Thereafter, as shown in (c) of FIG. 15A, the processor 870 may determine a parking space available for parking based on the sensed peripheral information and output information 1500a related to a parking space determined in the left area of the vehicle and information 1500b related to a parking space determined in the right area of the vehicle, on the display unit 820.

Meanwhile, as shown in (a) of FIG. 15B, when the corresponding parking passage is determined as a two-way road based on the information 1510 and 1520 written in the parking passage, the peripheral information of the vehicle may be sensed only in one of the left area and the right area of the vehicle.

For example, as shown in (b) of FIG. 15B, when the vehicle 100 keeps to the left in the parking passage, the processor 870 may sense the peripheral information of the vehicle 100 in the left area 1530 of the vehicle 100.

Thereafter, as shown in (c) of FIG. 15B, the processor 870 may determine a parking space in which the vehicle may be parked based on the peripheral information of the vehicle sensed in the left area of the vehicle, and output information 1500a related to the parking space determined in the left area of the vehicle on the display unit 820.

Meanwhile, as shown in FIG. 15C, when a touch is applied to information related to the parking space output on the display unit 820, the processor 870 may automatically park the vehicle.

At this time, the processor 870 may automatically park the vehicle 100 in the parking space corresponding to the touched information. While the automatic parking is being performed, the processor 870 may control the lamp provided in the vehicle 100 in a preset manner. For example, the processor 870 may blink an emergency light of the vehicle while automatic parking is being performed.

Meanwhile, as shown in (a) of FIG. 15D, when the present vehicle 100 exists in the parking lot 1500, the processor 870 may output information 1550a related to the parking space available for parking on the display unit.

Thereafter, when the present vehicle 100 leaves the parking lot 1500, the processor 870 may change the information 1550a related to the parking space available for parking to information 1550b indicating that parking is impossible.

When the vehicle 100 enters the parking lot 1500, the processor 870 related to the present invention may output map information related to the corresponding parking lot 1500 on the display unit 820.

Here, the map information associated with the parking lot 1500 may include a whole map of the parking lot which the vehicle 100 has entered, and information related to a parking space of the corresponding parking lot.

The vehicle control device 800 related to the present invention may further include a communication unit (for example, the communication device 400). The processor 870 may receive map information related to the parking lot 1500 from an external device (e.g., a server, a communication device, and the like, included in the parking lot 1500) through the communication unit.

The map information related to the parking lot received through the communication unit may include information related to a real-time parking status of the parking lot.

Accordingly, when the vehicle 100 enters the parking lot 1500, the processor 870 may output information related to the whole map of the parking lot and the parking space available for parking based on the map information associated with the parking lot 1500 on the display unit 820.

As described in FIGS. 15A to 15D, in the present invention, the information related to the parking space available for parking may be output on a partial space in the parking lot 1500 based on the present vehicle 100 may be output but the present invention is not limited thereto.

That is, when the vehicle 100 enters the parking lot 1500, the processor 870 related to the present invention may output the whole map of the parking lot 1500 on the display unit 820 and output at least one of information related to a parking space available for parking and information related to a space in which parking is impossible on the whole map.

For example, the processor 870 may output a whole map of the corresponding parking lot based on the map information associated with the parking lot received through the communication unit, and output at least one of the parking space available for parking and the space in which parking is impossible on the whole map.

According to an embodiment of the present invention, there is one or more of the following effects.

First, according to the present invention, information related to a parking space is output on the display unit in a different manner based on the type of a road on which the vehicle is located when the vehicle is parked, thereby providing a new user interface for informing the user about a parking space according to situations in an optimized manner.

Secondly, in the present invention, a space available for parking and a space in which parking is impossible are displayed to be distinguished from each other when the vehicle is parked, thereby effectively informing the user about whether the corresponding parking space is available for parking.

Thirdly, according to the present invention, the peripheral information necessary for determining a parking space is sensed in different areas based on the type of the road on which the vehicle is located when the vehicle is parked, thereby effectively controlling the sensor and providing a control method for searching for a parking space in a wide area according to situations, or precisely searching for a parking space in a partial area.

The effects of the present invention are not limited to the effects mentioned above, and other effects not mentioned may be clearly understood by those skilled in the art from the description of the claims.

The vehicle control device 800 described above may be included in the vehicle 100.

The operation or the control method of the vehicle control device 800 described above may be inferred and applied in the same/similar manner as the operation or control method of the vehicle (or the controller 170).

For example, the control method of the vehicle 100 (or the control method of the vehicle control device 800) may include a step of sensing peripheral information of the vehicle, a step of determining a parking space in which the vehicle can be parked based on the sensed peripheral information, and outputting information related to the determined parking space on the display unit.

Here, in the outputting step, the information related to the parking space may be output on the display unit in a different manner based on the type of the road on which the vehicle is located.

Each of the above steps may be performed not only by the vehicle control device 800 but also by the controller 170 provided in the vehicle 100.

Further, all of the functions, configurations, or control methods performed by the vehicle control device 800 described above may be performed by the controller 170 provided in the vehicle 100. That is, all of the control methods described in this specification may be applied to a control method of a vehicle or a control method of a control device.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the processor or the controller. Therefore, it should also be understood that the above-described embodiments are not limited by any of the details of the foregoing description, unless otherwise specified, but rather should be construed broadly within its scope as defined in the appended claims, Therefore, all changes and modifications that fall within the metes and bounds of the claims, or equivalents of such metes and bounds are therefore intended to be embraced by the appended claims.

1. A vehicle control device provided in a vehicle, the vehicle control device comprising:
a sensing unit for sensing peripheral information of the vehicle;
a display unit; and
a processor for determining a parking space in which the vehicle can be parked on the basis of the sensed peripheral information, and outputting information related to the determined parking space on the display unit,
wherein the processor outputs the information related to the parking space on the display unit in different methods on the basis of the type of road on which the vehicle is located.

2. The vehicle control device of claim 1, wherein if the type of the road on which the vehicle is located is a first type, the processor outputs information related to the parking space detected on the left and right sides of the vehicle on the display unit, and if the type of the road on which the vehicle is located is a second type different from the first type, the processor outputs information related to the parking space detected from any one of the left and right sides of the vehicle on the display unit.

3. The vehicle control device of claim 2, wherein the processor outputs, on the display unit, information related to a parking space existing in a direction opposite to a direction in which a center line of the left and right sides of the vehicle is detected in the second type road.

4. The vehicle control device of claim 1, wherein when preset information is sensed in the parking space the processor determines that the corresponding parking space is a space in which parking is prohibited.

5. The vehicle control device of claim 4, wherein the processor outputs the parking space in which the vehicle can be parked and the space in which parking is inhibited so as to be visually distinguished from each other.

6. The vehicle control device of claim 1, wherein when a lane in which the vehicle is running is a preset lane, the processor outputs information related to the parking space on the display unit, and when the lane in which the vehicle is running is not the preset lane, the processor outputs information indicating that parking is impossible in the lane on the display unit.

7. The vehicle control device of claim 1, wherein the processor controls the sensing unit to sense to sense peripheral information required for determining the parking space in which the vehicle can be parked in different areas based on the type of the road on which the vehicle is located.

8. The vehicle control device of claim 7, wherein if the road on which the vehicle is located is a first type road, the processor senses the peripheral information in a left area and a right area of the vehicle, and if the road on which the vehicle is located is a second type road different from the first type road, the processor senses the peripheral information only in any one of the left area and the right area.

9. The vehicle control device of claim 8, wherein if the road on which the vehicle is located is the second type road, the processor controls the sensing unit to sense the peripheral information in an area in which the center line is not included, among the left area and the right area.

10. The vehicle control device of claim 1, wherein when the vehicle is located in a parking lot, the processor outputs information related to the parking space in which the vehicle can be parked on the display unit in different manners according to whether a corresponding parking passage is a one-way road or a two-way road.

11. The vehicle control device of claim 1, wherein when the vehicle passes by a specific point based on the parking space in which the vehicle can be parked, the processor changes the information related to the parking space output on the display unit from the parking available space to a parking unavailable space.

12. The vehicle control device of claim 11, wherein the specific point is varied depending on the type of road on which the vehicle is located.

13. The vehicle control device of claim 1, wherein when a touch is applied to the information related to the parking space output on the display unit, the processor automatically parks the vehicle.

14. A vehicle including the vehicle control device of claim 1.

15. A method of controlling a vehicle including a vehicle control device, the method comprising:
sensing peripheral information of a vehicle;
determining a parking space in which the vehicle can be parked based on the sensed peripheral information; and
outputting information related to the determined parking space on the display unit,
wherein, in the outputting, the information related to the parking space is output on the display unit in different manners based on the type of a road on which the vehicle is located.
